(19) United States
(12) Patent Application Publication
(10) Pub. No.: US 2024/0375795 A1
(43) Pub. Date: Nov. 14, 2024

(54) ELECTROMAGNETIC PROPULSION DEVICE FOR GENERATING UNIDIRECTIONAL FORCE AND METHOD THEREOF

(71) Applicant: Rohit Gadagkar, Bengaluru (IN)

(72) Inventor: Rohit Gadagkar, Bengaluru (IN)

(21) Appl. No.: 18/642,946

(22) Filed: Apr. 23, 2024

(30) Foreign Application Priority Data
Apr. 25, 2023 (IN) 202341029927

(51) Int. Cl. B64G 1/40

(52) U.S. Cl. CPC B64G 1/417; B64G 1/409

(57) ABSTRACT

The present invention discloses an electromagnetic propulsion device for generating unidirectional force and method thereof. The electromagnetic propulsion device comprises one or more pod units, a power source, a control unit. Each pod unit comprises an enclosure, one or more magnetic flux-controlling cores, one or more pairs of magnetic materials, and one or more electrically conductive elements. The one or more pod units operatively form a structure of the vehicle in a pre-defined shape, configured to generate the unidirectional force. The pre-defined shape is configured to provide a distributed propulsion and a control redundancy based on arranging the one or more pod units in defined geometries to form the structure of the vehicle. The control unit is configured to activate and deactivate the one or more pod units, regulate thrust levels, and change propulsion direction of the vehicle.

### EARLIEST PRIORITY DATE

This application claims priority from a Provisional patent application filed in India having patent application No. 202341029927, filed on Apr. 25, 2023, and titled “LINEAR THRUSTER AND STRUCTURAL ELECTROMAGNETIC PROPULSION SYSTEM”.

### TECHNICAL FIELD

Embodiments of the present disclosure relate to vehicle propulsion systems, and more particularly relate to an electromagnetic propulsion device for generating unidirectional force. The electromagnetic propulsion device enables vehicle propulsion in various environments, comprising air, water, or vacuum, without being limited by the properties of the surrounding material medium.

### BACKGROUND

Existing propulsion methods typically involve imparting momentum to a fluid, either within a vehicle or in the surrounding medium like air or water, to generate thrust in an opposite direction. However, this approach often leads to various undesirable side effects such as vortices, pressure imbalances, vibration, noise, and turbulence, resulting in energy wastage and reduced propulsion efficiency. Common methods like electric motors or internal combustion engines rely on rotating components such as wheels or propellers to convert friction or fluid flow into linear thrust. These methods suffer from drawbacks such as moving parts, energy loss due to power conversion, and inefficiencies caused by the interaction between rotating parts and the environment. For instance, propeller efficiency is heavily influenced by factors like fluid velocity, turbulence, blade design, operating conditions and specific mediums like air or water, leading to varying levels of effectiveness. Rockets typically carry about 90% fuel for 1% payload by weight with an operating efficiency of around 70%. Like jet engines a large amount of fuel is converted to gas to generate a reaction force for propulsion.

Conventional linear motors have a limited range of linear motion. Magnetic levitation-based propulsion, commonly employed in trains, relies on a relative motion between a rotor and a stator, often with a significant air gap between them. Superconducting magnets, which are significantly more powerful than conventional electromagnets, are necessary to compensate for a drop in magnetic field strength across this air gap. Linear actuators and magnetic levitation systems typically utilize three-phase alternating current (AC) inverters, necessitating expensive high-frequency electronics for speed control such as variable frequency drives (VFDs). This necessitates the use of special composite alloys with high electrical resistance, low hysteresis loss, electrical brushes for grounding induced currents in shafts and bearings and liquid cooling through specially designed tubing.

In the existing electromagnetic propulsion technology, a segmented current magnetic field propulsion system is disclosed in U.S. Pat. No. 10,513,353 comprising field coils and conductor coils wound as solenoids with alternating segments of magnetic field shield assemblies. This system does not use magnetic materials or magnetic flux pathways. Instead, it requires a specific alignment and interaction between a field coil and an unshielded segment of a horizontal conduction coil wherein concentric circular magnetic field lines from vertical oriented segments of a field coil create normal components of a magnetic field with varying magnitude by location along the length of the conduction coil. One problem with this system is that horizontal segments of field coil generate opposing forces in the conduction coil which cancel out. The angle between the magnetic field and current varies along the conduction coil and is significantly lower than 90° resulting in a less than optimum Lorentz force. Magnetically shielded segments of the conduction coil incur power losses and do not generate propulsive force.

Therefore, there is a need for a device that addresses the limitations of existing propulsion systems.

### OBJECTIVES OF THE DISCLOSURE

A primary objective of the present disclosure is to provide a propulsion system to generate unidirectional force with relatively high efficiency, durability, and minimal wear and tear with no moving parts or stator components.

Another objective of the present disclosure is to achieve higher efficiency by eliminating rotary to linear propulsion conversion devices such as motor driven propellers.

Yet another objective of the present disclosure is to make propulsion force independent of the surrounding fluid medium, enabling terrestrial and space applications.

The other object of the present disclosure is to eliminate the need for inverters/Variable Frequency Drive (VFD), high frequency switching devices and time varying magnetic fields in stator coils.

Yet another object of the present invention is to avoid relative motion between a stator and armature/moving component which requires a significantly large air gap resulting in reduced magnetic field strength.

These and other objects and advantages of the present technology will become readily apparent from the following detailed description taken in conjunction with the accompanying drawings.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

The present disclosure of an electromagnetic propulsion device for generating unidirectional force achieves the above objectives and offers substantial advantages over prior art propulsion devices.

In accordance with an embodiment of the present disclosure, the electromagnetic propulsion device comprises one or more pod units, a power source, and a control unit. The one or more pod units is configured to form one or more pod groups. The one or more pod groups is configured to form a base component by a fastening mechanism. The one or more pod units configured with a polygonal shape comprises one of a: rectangle shape, circle shape, pentagon shape, hexagon shape, and octagon shape. A shape of the one or more magnetic flux-controlling cores and the shape of the one or more electrically conductive elements correlate with the polygonal shape of the one or more pod units.

In an embodiment, the one or more pod groups comprises one or more sensors and a transceiver module. The one or more sensors is operatively positioned proximal to each pod unit. The one or more sensors is configured to generate sensor data containing operational data of an associated pod unit of the one or more pod units. The transceiver module is configured to transmit at least one of: telemetry data, the sensor data, system configuration data, status, and positioning data to the control unit through a communication network. The transceiver module is also configured to receive one or more parameters comprises at least one of: activate and deactivate one or more pod units 102, regulate thrust levels, and change propulsion direction.

In an embodiment, each pod unit of the one or more pod units comprises an enclosure, one or more magnetic flux-controlling cores, one or more pairs of magnetic materials, and one or more electrically conductive elements. The enclosure is configured to provide a structural support to each pod unit of the one or more pod units.

In one embodiment, the one or more magnetic flux-controlling cores is operatively positioned inside the enclosure. The one or more magnetic flux-controlling cores is configured to optimise the unidirectional force generated in each pod unit of the one or more pod units along a thrust axis. The one or more magnetic flux-controlling cores is operatively positioned in the enclosure through one or more pairs of fasteners. The one or more pairs of fasteners comprises screws, actuation units, magnetic clamps, spring-loaded pins, magnetic brackets, and snap-fit connectors. The one or more magnetic flux-controlling cores comprises a first surface. The first surface is configured with a first material with a relative permeability ranging between 1 and 200000 positioned normal to the thrust axis. The first material is configured to generate an optimum magnetic field gradient.

In another embodiment, the one or more pairs of magnetic materials is operatively positioned on opposite sides of the one or more magnetic flux-controlling cores. The one or more pairs of magnetic materials is configured to provide a magnetic field. Each pair of magnetic materials of the one or more pairs of magnetic materials is positioned on opposite sides of the one or more magnetic flux-controlling cores, with like poles directed towards the one or more magnetic flux-controlling cores. Each magnetic material within each pair of magnetic materials is positioned on the one or more magnetic flux-controlling cores at a pre-defined distance and aligned in one of a: normal orientation and angular orientation.

In another embodiment, the one or more electrically conductive elements is operatively positioned along a periphery of the one or more magnetic flux-controlling cores. The one or more electrically conductive elements is configured to generate an optimum first force orthogonal to the magnetic field and direct current. The one or more electrically conductive elements is configured with a flat profile containing a defined number of windings. In another embodiment the one or more electrically conductive elements is selected from a group of superconducting materials exhibiting a Meissner Effect.

In an embodiment, the power source is electronically connected to the one or more pod units. The power source is configured to provide the direct current to the one or more electrically conductive elements. The electromagnetic propulsion device comprises one or more circuit components. The one or more circuit components is configured to connect the one or more pod units with the power source for controlling a flow of the direct current and polarity within each pod unit of the one or more pod units. The one or more circuit components selected from a group comprises at least one of: diodes, metal-oxide-semiconductor field-effect transistors (MOSFETs), double-pole double-throw (DPDT) relays, solid-state switches, insulated-gate bipolar transistor (IGBT), and Semiconductor Controlled Rectifier (SCR).

In one embodiment, the control unit is operatively connected to the one or more pod units and the power source. The control unit is configured to control the one or more parameters associated with the one or more pod units for generating the unidirectional force. The one or more parameters comprises at least one of: activate and deactivate one or more pod units 102, regulate thrust levels, and change propulsion direction.

In another exemplary embodiment, the electromagnetic propulsion device is formed by fabrication on a printed circuit board (PCB) as one or more Micro-Electro-Mechanical Systems (MEMS) units. The one or more magnetic flux-controlling cores associated with the one or more Micro-Electro-Mechanical Systems (MEMS) units comprises at least one of: ferrite rings, thin films, and ferromagnetic material. The one or more electrically conductive elements associated with the one or more Micro-Electro-Mechanical Systems (MEMS) units are etched on a first surface and a second surface of the printed circuit board (PCB).

In accordance with another embodiment of the present disclosure, a vehicle based on the electromagnetic propulsion device is disclosed. The electromagnetic propulsion device is configured for generating unidirectional force. The electromagnetic propulsion device comprises the one or more pod units, the power source, and the control unit. The one or more pod units is operatively forming a structure of the vehicle in a pre-defined shape. The pre-defined shape is configured to provide a distributed propulsion and a control redundancy based on arranging the one or more pod units in defined geometries to form the structure of the vehicle. Each pod unit of the one or more pod units comprises the enclosure, the one or more magnetic flux-controlling cores, the one or more pairs of magnetic materials, the one or more electrically conductive elements.

In an embodiment, the enclosure is configured to provide a structural support to each pod unit of the one or more pod units. The one or more magnetic flux-controlling cores is operatively positioned inside the enclosure, with one or more pairs of magnetic materials operatively positioned on opposite sides of the one or more magnetic flux-controlling cores to provide a magnetic field. The one or more electrically conductive elements is operatively positioned along a periphery of the one or more magnetic flux-controlling cores to generate an optimum first force. The first force refers to the Lorentz force which is a cross-product of current and magnetic field in the electrically conductive elements and is oriented orthogonally to both as indicated in FIG. 3C.

In one embodiment, the one or more pod units is configured to form one or more pod groups. The one or more pod groups is configured to form a base component by a fastening mechanism. The one or more pod groups is symmetrically disposed about a centre of mass of the vehicle. The one or more pod groups is operatively connected to the control unit through the communication network for triggering the one or more parameters in a coordinated manner. The one or more pod units within the one or more pod groups is configured to generate the unidirectional force independently. The one or more pod units is operatively forming the structure of the vehicle exterior to a cabin. The cabin is selected from a group of magnetic shielding materials comprises at least one of: ferromagnetic materials, mu-metal alloys, and superconducting materials configured to mitigate electromagnetic interference.

In another embodiment, the power source is electronically connected to the one or more pod units. The power source is configured to provide direct current to the one or more electrically conductive elements. The control unit is operatively connected to the one or more pod units and the power source. The control unit is configured to control one or more parameters associated with the one or more pod units for propelling the vehicle in a defined direction. The control unit is configured to orchestrate synchronized operation of the vehicle by controlling the one or more pod units configured at least one of: homogenously and heterogeneously to achieve a stepwise thrust control, desired trajectory, manoeuvres, acceleration, deceleration, and maintenance of constant speed. The control unit is configured to remotely trigger the activation and deactivation of the one or more pod units for controlling the vehicle. The control unit is configured to alter the direction of propulsion by selectively activating the one or more pod units asymmetrically about a central body axis of the vehicle to produce a torque about the centre of mass of the vehicle for maneuvering the vehicle.

In yet another embodiment, the vehicle comprises a cooling subsystem. The cooling subsystem is configured to dissipate heat generated by the one or more pod units. The cooling subsystem is selected from a group comprises at least one of: air cooling subsystems, liquid cooling subsystems, and thermoelectric cooling subsystems. In another embodiment, the vehicle comprises one or more sensors. The one or more sensors is operatively positioned proximal to each pod unit. The one or more sensors is configured to generate sensor data containing positioning data, mapping data, navigation data, path planning data, waypoint navigation data, trajectory control data and course correction data.

In accordance with another embodiment, a method for generating unidirectional force by the electromagnetic propulsion device is disclosed. In the first step, the method includes providing, by the one or more pairs of magnetic materials, the magnetic field in the one or more pod units. In the next step, the method includes providing, by the power source, the direct current to one or more electrically conductive elements. In the next step, the method includes generating, by the one or more electrically conductive elements, the optimum first force orthogonal to the magnetic field and the direct current. In the next step, the method includes optimising, by the one or more magnetic flux-controlling cores, the unidirectional force generated in the one or more pod units along the thrust axis based on the first force. In the next step, the method includes controlling, by the control unit, one or more parameters associated with the one or more pod units to generate the unidirectional force.

To further clarify the advantages and features of the present invention, a more particular description of the invention will follow by reference to specific embodiments thereof, which are illustrated in the appended figures. It is to be appreciated that these figures depict only typical embodiments of the invention and are therefore not to be considered limiting in scope. The invention will be described and explained with additional specificity and detail with the appended figures.

### BRIEF DESCRIPTION OF THE DRAWINGS

The disclosure will be described and explained with additional specificity and detail with the accompanying figures in which:

FIG. 1A illustrates an exemplary electromagnetic propulsion device for generating the unidirectional force, in accordance with an embodiment of the present disclosure;

FIG. 1B illustrates an exemplary block diagram depicting the electromagnetic propulsion device, in accordance with an embodiment of the present disclosure;

FIG. 2 illustrates an exemplary one or more Micro-Electro-Mechanical Systems (MEMS) units, in accordance with an embodiment of the present disclosure;

FIG. 3A illustrates an exemplary side view of a rectangular pod unit with the one or more electrically conductive elements symmetrical to the one or more magnetic flux-controlling cores, in accordance with an embodiment of the present disclosure;

FIG. 3B illustrates an exemplary side view of the rectangular pod unit with the one or more electrically conductive elements asymmetrical to the one or more magnetic flux-controlling cores, in accordance with an embodiment of the present disclosure;

FIG. 3C illustrates an exemplary three-dimensional space representing a direction of forces in the rectangular pod unit, in accordance with an embodiment of the present disclosure;

FIG. 4 illustrates an exemplary isometric view of the one or more pod units with the pie shape, in accordance with an embodiment of the present disclosure;

FIG. 5 illustrates an exemplary circular grid component, in accordance with an embodiment of the present disclosure;

FIG. 6 illustrates an exemplary top view of concentric arrangements of the one or more pod units on a flat disc resulting in a circular grid of pod units, in accordance with an embodiment of the present disclosure;

FIG. 7 illustrates an exemplary annular arrangement of polygonal pod units, in accordance with an embodiment of the present disclosure;

FIGS. 8A and 8B illustrate an exemplary top view and the sectional view of a multi-level circular tower, in accordance with an embodiment of the present disclosure;

FIG. 9 illustrates an exemplary sectional view of an alternative cylindrical tower, in accordance with an embodiment of the present disclosure;

FIG. 10 illustrates an exemplary solid polygonal tower component, in accordance with an embodiment of the present disclosure;

FIG. 11 illustrates an exemplary a four-level polygonal stepped pyramid component, in accordance with an embodiment of the present disclosure;

FIG. 12A illustrates an exemplary top view multi-level circular stepped pyramid component, in accordance with an embodiment of the present disclosure;

FIG. 12B illustrates an exemplary sectional view of the multi-level circular stepped pyramid component, in accordance with an embodiment of the present disclosure;

FIG. 13 illustrates an exemplary sectional view of a vehicle with a multi-level circular stepped pyramid with a conical shell, in accordance with an embodiment of the present disclosure;

FIG. 14 illustrates an exemplary vehicle with a circular tapered tower vehicle, in accordance with an embodiment of the present disclosure;

FIG. 15 illustrates an exemplary bi-cone vehicle, in accordance with an embodiment of the present disclosure;

FIG. 16 illustrates an exemplary Short Take Off and Landing (STOL) vehicle, in accordance with an embodiment of the present disclosure;

FIG. 17 illustrates an exemplary Vertical Take Off and Landing (VTOL) car, in accordance with an embodiment of the present disclosure;

FIG. 18 illustrates an exemplary flowchart of a method for generating the unidirectional force by an electromagnetic propulsion device, in accordance with an embodiment of the present disclosure; and

FIG. 19 illustrates an exemplary graphical representation of components of forces, in accordance with an embodiment of the present disclosure.

Further, those skilled in the art will appreciate that elements in the figures are illustrated for simplicity and may not have necessarily been drawn to scale. Furthermore, in terms of the method steps, chemical compounds, equipment, and parameters used herein may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

To enhance the comprehension of the principles of the disclosure, reference will now be made to the embodiments illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more components, compounds, and ingredients preceded by “comprises . . . a” does not, without more constraints, preclude the existence of other components or compounds or ingredients or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to an electromagnetic propulsion device for generating unidirectional force.

As used herein, the term “base component” refers to a structural element or part of a vehicle or the electromagnetic propulsion device composed of one or more pod units of diverse shapes arranged in specific geometries. These base components are designed to achieve particular characteristics such as thrust, torque, maneuverability, and aerodynamics. The base component may be constructed using various methods, including assembling one or more pod groups symmetrically about a central axis on a structural frame made of either ferromagnetic or non-magnetic material. The base component may be composed individually or combined to form composite structures using alignment and securing mechanisms such as one of an interlocking, bonding, and motor-driven screws. The term also encompasses the vehicle itself, which may consist of heterogeneous component types, each configured in the one or more pod groups to achieve diverse output characteristics.

In accordance with the objectives, various embodiments are presented herein of the one or more pod units which is the electromagnetic device that generates a unidirectional net force of which one factor is the Lorentz force, normal to the plane of one or more electrically conductive elements carrying static direct current (DC). Total momentum comprising the mechanical momentum of the electromagnetic propulsion device and electromagnetic field momentum is conserved in one or more pod groups. The Lorentz force (F) on the one or more electrically conductive elements within a single pod unit of volume (V) in an electromagnetic field, is obtained by integrating the Maxwell stress tensor.

$$F = ∮ \overleftrightarrow{T} \cdot dA - {ε}_{0} {μ}_{0} {\int }_{V} \frac{\partial s}{\partial t} dV \qquad Equation 1$$

where S is the pointing vector representing the Power density transported by the field, [symbol] is net stress acting on an infinitesimal surface represents the momentum flux density and the first term represents the rate of momentum flowing through a surface. The rate of change of total momentum within the enclosed volume includes both Mechanical momentum (P_{M}) and Electromagnetic Field momentum:

$$\frac{\partial }{\partial t} ( {P}_{M} + {ε}_{0} {μ}_{0} {\int }_{V} S dV ) = ∇ \cdot \overleftrightarrow{T} \qquad Equation 2$$

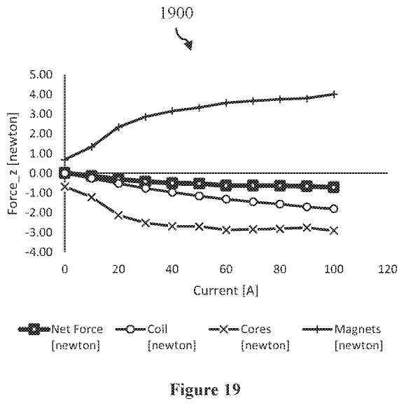

In the absence of an external force, momentum change is caused by field momentum flowing in or out of the finite volume (V) and outgoing power flux from a power source is transferred to the electromagnetic field resulting in the Poynting vector pointing radially inward from outside the pod. FIG. 19 illustrates the resultant non-zero unidirectional force and other component forces in a pod unit.

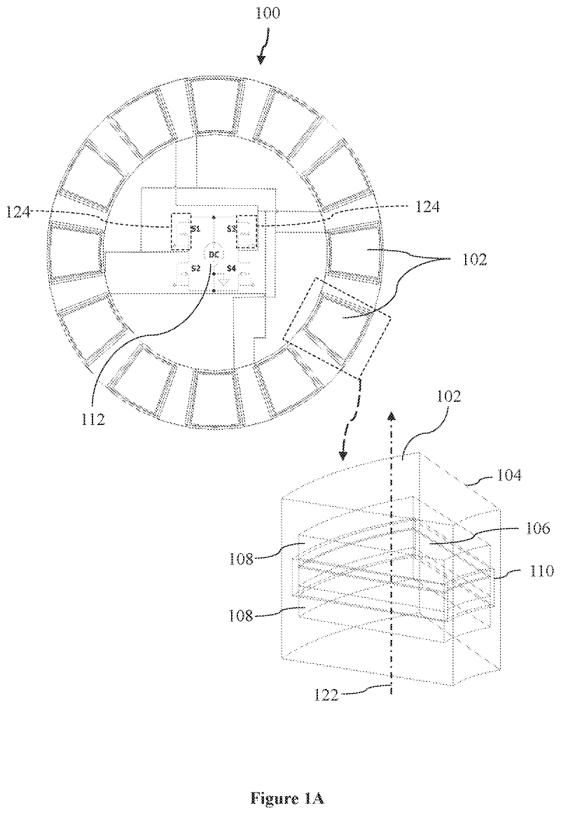

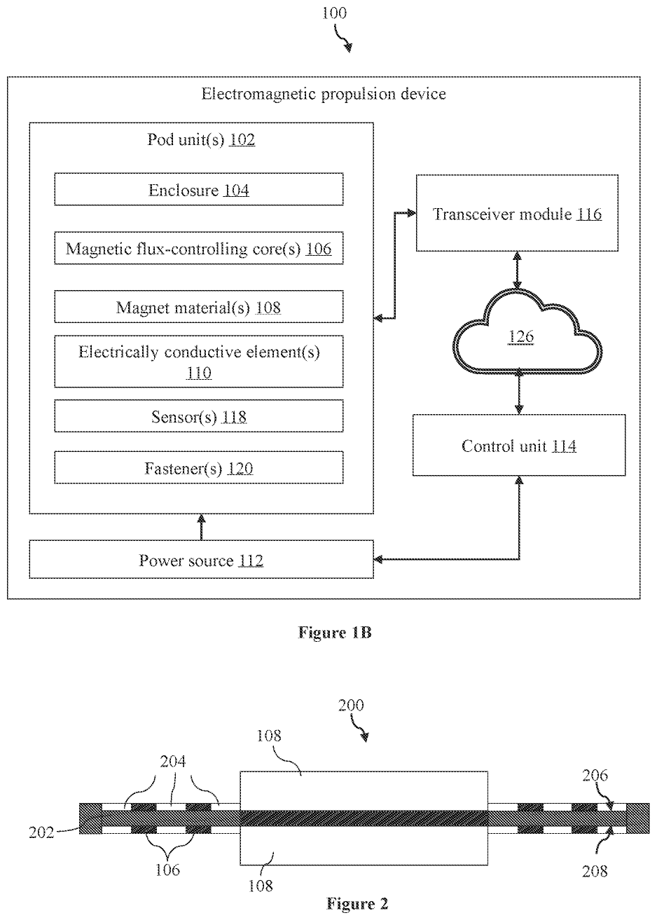

FIG. 1A illustrates an exemplary electromagnetic propulsion device 100 for generating the unidirectional force, in accordance with an embodiment of the present disclosure.

FIG. 1B illustrates an exemplary block diagram depicting electromagnetic propulsion device 100, in accordance with an embodiment of the present disclosure.

According to an exemplary embodiment of the present disclosure, the electromagnetic propulsion device 100 described herein comprises the one or more pod units 102, a power source 112, and a control unit 114. The one or more pod units 102 is an atomic unit of propulsion that generates the unidirectional force when powered by the DC from the power source 112. The one or more pod units 102 is configured with a polygonal shape comprising, but not limited to, one of a: rectangle shape, circle shape, pentagon shape, hexagon shape, octagon shape and the like. In other exemplary embodiments, the one or more pod units 102 may configured with three edges or those with more than eight edges are within the scope of the present disclosure but may be less preferred. The one or more pod units 102 comprises, but not limited to, an enclosure 104, one or more magnetic flux-controlling cores 106, one or more pairs of magnetic materials 108, and one or more electrically conductive elements 110. A shape of the: enclosure 104, one or more magnetic flux-controlling cores 106, one or more pairs of magnetic materials 108, and one or more electrically conductive elements 110 are configured to correlate with the polygonal shape of the one or more pod units 102. In an alternative exemplary embodiment, the shape of the: enclosure 104, one or more magnetic flux-controlling cores 106, one or more pairs of magnetic materials 108, one or more electrically conductive elements 110, may not be correlate with the polygonal shape of the one or more pod units 102.

In an exemplary embodiment, the enclosure 104 is configured to provide a structural support to each pod unit 102 of the one or more pod units 102. The enclosure 104 may be made of ferromagnetic material. In an alternative exemplary embodiment, the one or more pod units 102 may not configured with the enclosure 104. In another exemplary embodiment, depending on the overall one or more pod unit 102 geometry the enclosure may consist of the one or more magnetic flux-controlling cores 106 covering outer faces of the enclosure 104, effectively shielding the enclosure 104 magnetically and the one or more magnetic flux-controlling cores inside the enclosure 104 parallel to the thrust axis 122.

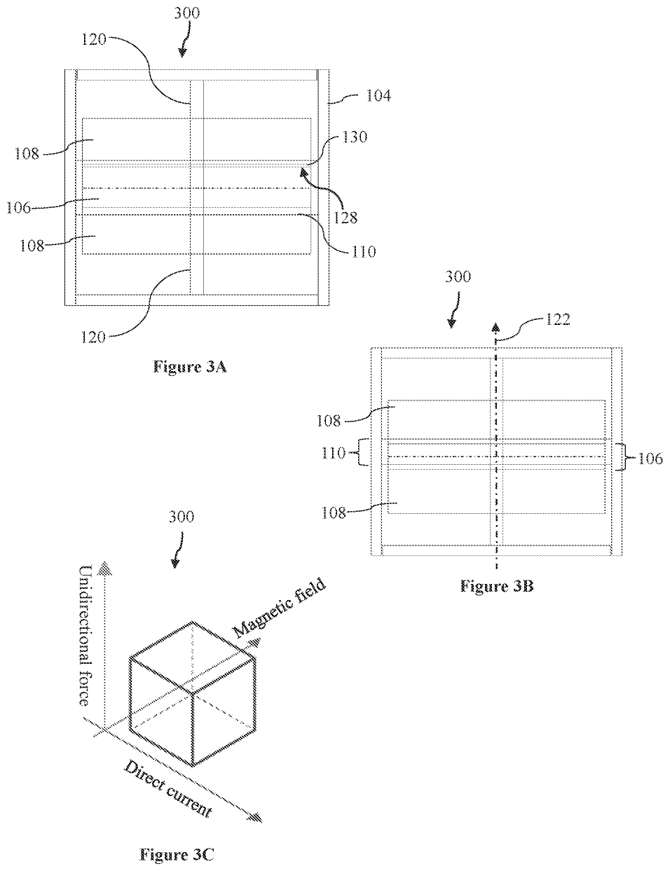

In an exemplary embodiment, the one or more magnetic flux-controlling cores 106 is operatively positioned inside the enclosure 104. The one or more magnetic flux-controlling cores 106 is configured to optimise the unidirectional force generated in each pod unit 102 of the one or more pod units 102 along a thrust axis 122. The one or more magnetic flux-controlling cores 106 is operatively positioned in the enclosure 102 through one or more pairs of fasteners 120 (as depicted in FIG. 3A). The one or more pairs of fasteners 120 comprises, but not limited to, one of: screws, actuation units, magnetic clamps, spring-loaded pins, magnetic brackets, snap-fit connectors and the like. The one or more magnetic flux-controlling cores 106 comprises a first surface. The first surface 128 is configured with a first material 130 with a relative permeability ranging between 1 and 200000 positioned normal to the thrust axis 122. The first material 130 is configured to generate an optimum magnetic field gradient. In an exemplary embodiment, the first surface 128 is made of ferrite and the first material 130 is made of low carbon steel. The first surface 128 is one of a top surface and bottom surface of the one or more magnetic flux-controlling cores 106. In an alternative exemplary embodiment, the one or more magnetic flux-controlling cores 106 may be constructed from one of a superconducting material and ferromagnetic material. In one exemplary embodiment, the one or more magnetic flux-controlling cores 106 may be one of an annular, and toroidal in shape. Additionally, variations in the geometry of the one or more magnetic flux-controlling cores 106, such as, but not limited to tapered or stepped designs, may be implemented to further optimize magnetic flux control and enhance propulsion efficiency.

In an alternative exemplary embodiment, the one or more pod units 102 may contain a thin layer of material with low relative magnetic permeability on one side of the sandwiched one or more magnetic flux-controlling cores 106 between the one or more pairs of magnetic materials 108. In an alternative exemplary embodiment, the one or more pod units 102 may include rotational axes parallel to the surface of the sandwiched one or more magnetic flux-controlling cores 106 along which one set of one or more pairs of magnetic materials 108 may optionally be rotatable to maximise magnetic flux normal to the surface of the sandwiched one or more magnetic flux-controlling cores 106. The one or more pairs of magnetic materials 108 on the other side of the sandwiched one or more magnetic flux-controlling cores 106 may not be rotatable and placed in contact with the sandwiched one or more magnetic flux-controlling cores 106 surface. The degree of rotation is proportional to DC in the one or more electrically conductive elements 110. Yet another exemplary embodiment, the one or more pod units 102 may contain the one or more magnetic flux-controlling cores 106 along the thrust axis 122 on either side of the one or more electrically conductive elements 110 with a thin material of low relative permeability occupying lateral gaps in the one or more magnetic flux-controlling cores 106 that is normal to the thrust axis 122.

In an exemplary embodiment, the one or more pairs of magnetic materials 108 is operatively positioned on opposite sides of the one or more magnetic flux-controlling cores 106. The one or more pairs of magnetic materials 108 is configured to provide a magnetic field. Specifically, each pair of magnetic materials 108 of the one or more pairs of magnetic materials 108 is arranged so that like poles face towards the magnetic flux-controlling cores 106. This arrangement enhances the effectiveness of the magnetic field generated by the one or more pairs of magnetic materials 108. Each magnetic material 108 within each pair of magnetic materials 108 is positioned on the one or more magnetic flux-controlling cores 106 at a pre-defined distance and aligned in, but not limited to, one of a: normal orientation and angular orientation to ensure precise control over the magnetic flux distribution within the one or more pod units 102. In another exemplary embodiment, the one or more pairs of magnetic materials 108 may be constructed from one of the superconducting materials and permanent magnets.

The permanent magnets in one or more pod units used for terrestrial applications may be replaced by coils made from high-temperature superconducting material which are excited by the occasional DC. These superconducting materials do not require the constant DC supply but are occasionally excited by the DC to maintain a constant current and magnetic field circulating within the near-zero resistance coil. The superconducting material cooled below its critical temperature may also replace a battery in such applications by storing magnetic potential energy with no current decay.

In an exemplary embodiment, the one or more electrically conductive elements 110 operatively positioned along a periphery of the one or more magnetic flux-controlling cores 106 is configured to generate an optimum first force which is oriented orthogonally to the magnetic field and the DC as indicated in FIG. 3C. The first force refers to a Lorentz force and is oriented along the geometric axis 122 of the one or more pod units 102. When the one or more electrically conductive elements 110, such as a coil of wire, carries the DC in the presence of the magnetic field, it experiences a force known as the Lorentz force which is represented by a cross product of the magnetic field and DC.

The one or more electrically conductive elements 110 is configured with a flat profile containing a defined number of windings with a uniform pitch. The one or more electrically conductive elements 110 is selected from a group of superconducting materials exhibiting a Meissner Effect. The superconducting materials comprises, but not limited to, one of: Bismuth strontium calcium copper oxide (BSCCO), Mercury Barium Calcium Copper Oxide (HgBaCaCuO), Yttrium Hydrides, Niobium-tin, Niobium-titanium and the like. In the illustrative embodiment, the one or more electrically conductive elements 110 are the coils of flat profile with a specific number of windings surrounding the one or more magnetic flux-controlling cores 106.

In an exemplary embodiment, the power source 112 is electronically connected to the one or more pod units 102. The power source 112 is configured to provide the DC to the one or more electrically conductive elements 110. The electromagnetic propulsion device 100 comprises one or more circuit components 124. On activation of the one or more pod units 102, the one or more circuit components 124 is configured to connect the one or more pod units 102 with the power source 112 for controlling a flow of the DC and polarity within each pod unit 102 of the one or more pod units 102 resulting in the generation of a net unidirectional force in the one or more pod units. On deactivation of the one or more pod units 102, the one or more circuit components is configured to disconnect the one or more pod units with the power source resulting in a zero net unidirectional force generated by the one or more pod units. The one or more circuit components 124 is selected from a group comprises, but not limited to, at least one of: diodes, metal-oxide-semiconductor field-effect transistors (MOSFETs), double-pole double-throw (DPDT) relays, solid-state switches, insulated-gate bipolar transistor (IGBT), Semiconductor Controlled Rectifier (SCR) and the like.

In an exemplary embodiment, the control unit 114 is operatively connected to the one or more pod units 102 and the power source 112. The control unit 114 is configured to control one or more parameters associated with the one or more pod units 102 for generating the unidirectional force. The one or more parameters comprises at least one of: activate and deactivate one or more pod units 102. In another exemplary embodiment, the control unit 114 is configured to rotate the one or more pod units 102 by using servos about an axis normal to the direction of thrust axis 122. The control unit 114 may be connected to a user interface in another exemplary embodiment. The user interface may be, but not limited to, at least one of a mobile device, a smartphone, a tablet computer, a laptop, a desktop, and the like. The user interface enables an end user with appropriate roles to interface with the control unit 114 to take over manual control, Preset and Fine-grained control, steering and thrust control to name a few.

In an exemplary embodiment, the one or more pod units 102 is configured to form one or more pod groups. The one or more pod groups is configured to form a base component by a fastening mechanism. The one or more pod groups comprises one or more sensors 118 and a transceiver module 116. The one or more sensors 118 is operatively positioned proximal to each pod unit 102. The one or more sensors 118 is configured to generate sensor data containing operational data of an associated pod unit 102 of the one or more pod units 102. The operational data refers to any information related to the functioning and performance of the associated pod unit 102 within the one or more pod groups 102. This operational data may include parameters such as, but not limited to, on and off conditions, temperature, pressure, magnetic field strength, voltage, current, power consumption, and any other relevant metrics that characterize the operation of the one or more pod units 102. The transceiver module 116 is configured to transmit at least one of: telemetry data, the sensor data, system configuration data, status, and positioning data to the control unit 114 through a communication network 126. The communication network 126 may be a wired communication network and/or a wireless communication network. The wireless communication network including point to point as well as mesh networking beacon, multicast or publish-subscribe protocols using standards such as, but not limited to, Bluetooth Low Energy (BLE), Zigbee, Thread and the like. The one or more pod groups remain on when activated by the control unit 114. On de-activation the one or more pod groups disconnect from the power source 112 and put the transceiver module 116 to sleep to conserve power. The control unit 114 is configured to broadcast and multicast messages transmitted by peers but initiated by the control unit 114 intended for the one or more pod groups. Semiconductor components and circuitry that allow unidirectional DC such as one of the diode, MOSFET, and equivalent may optionally be included. Optionally a DPDT relay and solid-state switch may be included to reverse voltage polarity applied to the one or more electrically conductive elements 110.

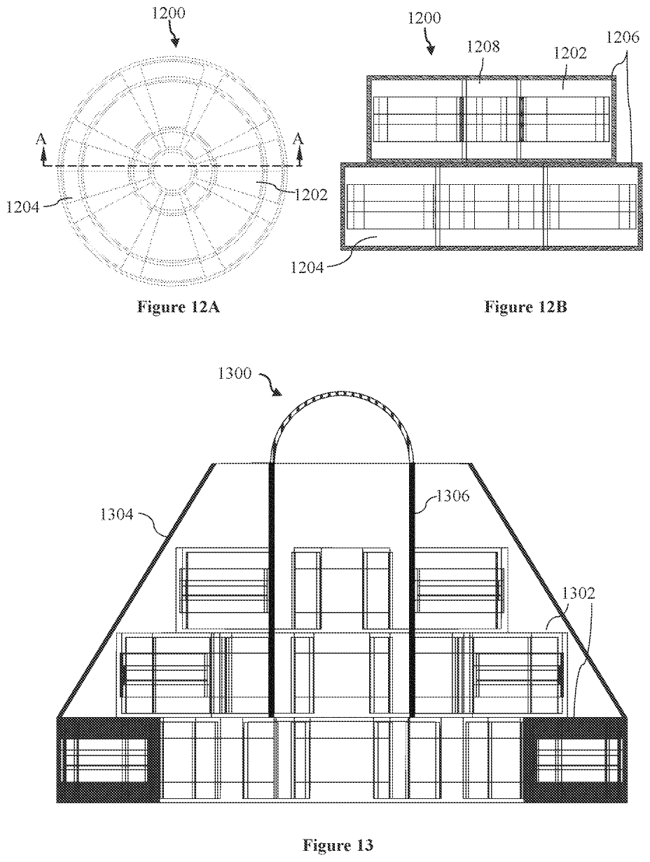

According to another exemplary embodiment of the present disclosure, the vehicle (as depicted in FIGS. 13, 14, 15, 16, 17) based on the electromagnetic propulsion device 100 is disclosed. The electromagnetic propulsion device 100 is configured to generate the unidirectional force. The unidirectional force refers to a propulsive force generated by the electromagnetic propulsion device 100 in a single defined direction. This unidirectional force is directed along the thrust axis 122 of the one or more pod units 102, providing propulsion without the need for complex mechanical systems or moving parts in the vehicle. The electromagnetic propulsion device 100 produces the unidirectional force, which in turn propels the vehicle forward in a specific direction. The one or more pod units 102 operatively form a structure of the vehicle in a pre-defined shape (as depicted in FIGS. 13, 14, 15, 16, 17). The pre-defined shape is configured to provide a distributed propulsion and a control redundancy based on arranging the one or more pod units in defined geometries to form the structure of the vehicle.

In an exemplary embodiment, the one or more pod units 102 may be grouped into electrically series-connected units or electrically isolated units with a minimum cardinality of one pod unit 102. The connected one or more pod units 102 may or may not be adjacent, but they are connected to a single power source 112. Different embodiments of vehicles and the one or more pod groups incorporate different assembly mechanisms and manufacturing processes optimized for various use cases and product grades.

In an exemplary embodiment, the one or more pod groups is symmetrically disposed about a centre of mass of the vehicle. The one or more pod groups is operatively connected to the control unit 114 through the communication network 126 for triggering the one or more parameters in a coordinated manner. The one or more pod units 102 within the one or more pod groups is configured to generate the unidirectional force independently. The one or more pod units 102 is operatively forming the structure of the vehicle exterior to a cabin. The cabin is selected from a group of magnetic shielding materials comprises, but not limited to, at least one of: ferromagnetic materials, mu-metal alloys, superconducting materials, and the like. The cabin is configured to mitigate electromagnetic interference.

In another embodiment, the power source 112 is electronically connected to the one or more pod units 102. The power source 112 is configured to provide the DC to the one or more electrically conductive elements 110. The control unit is configured to control one or more parameters associated with the one or more pod units 102 for propelling the vehicle in a defined direction. The one or more parameters comprises at least one of: activate and deactivate one or more pod units 102, regulate thrust levels, and change propulsion direction. The control unit 114 is configured to orchestrate synchronized operation of the vehicle by controlling the one or more pod units 102 configured at least one of: homogenously and heterogeneously to achieve a stepwise thrust control, desired trajectory, manoeuvres, acceleration, deceleration, and maintenance of constant speed. The control unit 114 is configured to remotely trigger the activation and deactivation of the one or more pod units 102 for controlling the vehicle. The control unit 114 is configured to alter the direction of propulsion by selectively activating the one or more pod units asymmetrically about a central body axis of the vehicle to produce a torque about the centre of mass of the vehicle for manoeuvring the vehicle.

In an exemplary embodiment, the vehicle comprises a cooling subsystem. The cooling subsystem is configured to dissipate heat generated by the one or more pod units 102. The cooling subsystem is selected from a group comprises at least one of: air cooing subsystems, liquid cooling subsystems, and thermoelectric cooling subsystems.

In an exemplary embodiment, the vehicle comprises one or more sensors 118. The one or more sensors 118 is operatively positioned proximal to each pod unit 102. The one or more sensors 118 is configured to generate sensor data containing positioning data, mapping data, navigation data, path planning data, waypoint navigation data, trajectory control data and course correction data. The one or more sensors may comprises at least one of: Positioning sensors, lidar sensors, radar sensors, sonar sensors, compasses, gyroscopes, cameras, environmental sensors, global positioning system (GPS), inertial measurement units (IMUs), accelerometers, trajectory control sensors, and the like. The control unit 114 may work in conjunction with an onboard or remotely located computer or one or more microcontroller modules that take inputs from the one or more sensors 118 to compute positioning, mapping, navigation, path planning, waypoint navigation, trajectory control and course correction to name a few and communicates commands during execution to the control unit 114.

Cardinality of the one or more pod units 102 in the one or more pod group may be determined using proprietary optimization algorithms or alternatively using algorithms that are well known in the art such as statistical, genetic, or deep learning algorithms. It may be noted that lower cardinality in the one or more pod groups enables nearly continuous thrust variation as groups are activated sequentially. Grouping of the one or more pod units also depends on the overall geometry of the vehicle, speed, and trajectory control characteristics desired where a plurality of Pod units symmetrically or asymmetrically located about the body axis at specific angular or axial locations may be grouped for desired control or thrust characteristics. This kind of grouping involves one or more electrically isolated pod subgroups arranged in specific geometries such as concentric polygons, grids, collections of pod units on one side of a symmetrical axis, and the like. Another potential strategy for grouping could be by the one or more pod unit types resulting in various subgroups within the base component or vehicle geometry that contain homogenous one or more pod units 102.

In an exemplary embodiment, standard and pre-set manoeuvres are achieved by switching predefined one or more pod groups on or off resulting in preset torque and thrust capability which is particularly useful to ferry cargo. In an alternative exemplary embodiment, the one or more pod groups comprising a gradient in the one or more pod unit's cardinality may be switched on or off sequentially by the control unit 114 thereby achieving fine-grained control.

In an alternative exemplary embodiment, unidirectional acceleration and thrust are achieved by activating the one or more pod units 102 or one or more pod groups located symmetrically around the central body axis of the vehicle. This may include one or more concentric polygonal rings containing pod units at the base or nose of the vehicle, one or more stacks of pod rings located at the outer body walls of the vehicle or groups of pod units comprising the structural body of a solid vehicle. Activating individual pod units 102 of the one or more pod units 102 or the one or more pod groups asymmetrically about the central body axis produces a torque about the vehicle's centre of mass.

In an alternative exemplary embodiment, the one or more pod units are attached to an outer wall of the vehicle and thereby considered structural elements. The geometrical layout of pod units vertically and horizontally produces specific thrust, torque, efficiency, and control characteristics for each geometrical configuration. Hollow vehicles are bounded by pod units along the outer walls and optionally along the base and nose of the vehicle around the central body axis. The hollow internal volume is the cabin may be divided into chambers to house various components of the vehicle including batteries, electronic components, passenger seating, cargo, and other equipment. In an alternative embodiment, the one or more pod units may fill the hollow volume resulting in a solid body with a higher thrust-to-volume ratio. This vehicle embodiment is not intended to ferry passengers and is meant for autonomous applications with higher payload-carrying capacity.

In an exemplary embodiment, Optional empty slots between the one or more pod units may house equipment such as the one or more sensors 118, power cables and one or more cells comprising a battery pack or alternatively may be open for increased air cooling in case of high-powered components. This applies for component or vehicle geometries with lower pod density using either Pie or Polygonal pod variants with empty interstitial pod space.

In an exemplary embodiment, all hollow variants of vehicle and component geometries may enclose their empty interior volume with the cabin made of a ferromagnetic shell that is sufficiently thick with optimum relative permeability and high saturation magnetisation to magnetically shield the interior from the field across the one or more pod units 102. The cabin may house electronic and other equipment that must be shielded from the magnetic field. Humans and other living occupants may also be housed in this cabin or a partition within. The cabin may further be divided into chambers for defined zones and functions such as bay area, storage etc. The cabin may optionally be coated or wrapped with heat shielding material.

Depending on the variant of the one or more pod units 102 used different embodiments of vehicles described in this disclosure may optionally contain an exterior ferromagnetic shell for magnetic shielding and for magnetic flux pathways across the one or more pod units 102 or alternatively lightweight exterior casing specifically shaped to improve aerodynamic characteristics of the vehicle. The underside of the external shell facing the internal chamber may optionally contain tubing or recess through which liquid cooling agents may be pumped in certain vehicle configurations using a large number of pod units 102 or high current or magnetic fields. This may optionally work in conjunction with fluid cooling vents. Other vehicle configurations may optionally include an external ferromagnetic shell made from a material of high relative permeability and high saturation magnetisation.

All vehicle configurations within the scope of this disclosure may include one primary fluid intake vent at the nose of the vehicle and optionally one or more secondary fluid intake vents along the body of the vehicle. In an alternative exemplary embodiment, the primary fluid intake vent may have an air-foil cross-section at a lip and a recess along the axis of the vehicle so that incoming fluid is accelerated into the recess and traverses axially across layers of the one or more pod units 102. The low pressure created at the inner surface across the intake vent in combination with the Coanda effect and vortex entrainment may cause fluid from the surrounding region to be sucked into the fluid intake vent and accelerated. The increased momentum imparted to incoming fluid generates a forward thrust from the pressure difference and increased turbulent flow within the recess increases heat transfer from the one or more pod units 102. Secondary annular fluid intake vents may optionally have a similar airfoil cross-section.

The one or more pod units 102 is cooled by incoming fluid either from a primary intake vent at the nose of the vehicle or secondary annular or pocket vents along the body of the vehicle. Fluid going past the lips becomes turbulent to an extent within the recess when it encounters the layers of the one or more pod units 102. This enables a higher degree of heat transfer and the air cooling of the one or more pod units 102. A larger lift force is required during the initial take-off and landing of the vehicle as it accelerates vertically against gravity. As the vehicle transitions into horizontal flight, it doesn't accelerate vertically and typically maintains constant horizontal speed using minimal horizontal force to overcome drag. In most conventional aircraft this is about a quarter of the force required during take-off. All air vents may be open during take-off and landing when potentially the one or more pod units 102 are switched on thereby requiring a higher degree of air cooling. In an alternative exemplary embodiment, the vents may be closed on transitioning to horizontal flight to reduce drag and due to lower cooling requirements as the one or more pod groups may be switched off.

Certain embodiments of vehicles, specifically of tower and pyramidal geometries may optionally include surface modifications particularly on the trailing edge of the body. These may include drag reduction devices such as dimples splines or annular corrugations along each face within each level of a tower or pyramid vehicle geometries. Tower and Pyramidal vehicles may also contain serrations along each edge at the intersection of perpendicular faces where one face is normal to, and the other face is parallel to the thrust direction.

Certain embodiments of vehicles specifically designed for travel in air or water may include air foils in the primary fluid intake vent at the nose, optional foldable wings and may optionally include rotary wings such as propellers that produce lift and thrust in the same direction as the one or more pod units 102 to enhance lifting capacity or vehicle speed.

The following are some candidate base component geometries and potential Vehicle configurations. It is not a comprehensive set of geometries but is indicative of some of the more efficient structural architectures that may be realized with the indicated geometrical arrangement of the one or more pod units 102 resulting in the high thrust-to-weight ratio of the overall vehicle. Additional vehicle geometries may be realized by extending the principles, techniques and specifications outlined which are still within the scope of the present disclosure.

In another exemplary embodiment, solid or hollow stepped pyramid base component geometries may be realized by arranging the one or more pod units 102 in concentric polygonal or circular rings with a constant slope. Height to width (or diameter) ratio may vary from 1.4 to 1.61. Two types of pyramids may be realized including a standard pyramid and a stepped pyramid. In an exemplary embodiment, an outer core in the standard pyramid embodiment has a tapering ferromagnetic core-shell with a continuous surface of constant slope encasing stacked layers of the one or more pod units 102, forming a conical pyramid. In an alternative exemplary embodiment, the hollow outer shell is a continuous core component that encases all layers of the one or more pod units 102 and may be of pyramidal or conical shape depending on the cross-section of each layer of the one or more pod units 102. The inner surface of the hollow outer shell may be stepped per pod layer as illustrated in FIG. 13 or continuous with a constant gradient across top to bottom pod layers. In an alternative stepped pyramid embodiment, one or more stacked pod units form the outer face of the stepped pyramid as illustrated in FIG. 11. Rectangular, cylindrical, and polygonal tower geometries may be realized by arranging the one or more pod units 102 in polygonal or circular layers which are stacked along the thrust axis 122. In some embodiments, the hollow body is realized by vertically stacking layers of a polygonal or circular arrangement of the one or more pod units 102 along the periphery of the vehicle body structure. In another exemplary embodiment, filling the interior void with the one or more pod units 102 results in a solid vehicle structure while retaining the same exterior tower geometry. Hollow polygonal or cylindrical towers may alternatively contain one or two grid or pyramidal end caps with a central hole so that the overall structure is still hollow.

Other embodiments may have more complex shapes formed by combining the basic shapes outlined above. For instance, a hyperboloid shape may be realized by attaching pyramidal and inverted pyramidal complex units at their apex wherein the latter unit has the current direction reversed in associated one or more pod groups. Bi-cone vehicle shapes may be realized in the same way by attaching two pyramidal complex units at their base and reversing the current direction in pod groups associated with one of the pyramids.

An illustrative embodiment of FIG. 1A depicts a pie or sector-shaped pod unit of the one or more pod units 102. In an alternative embodiment, the one or more pod units 102 includes a ferromagnetic outer core as the enclosure 104 covers along four polygonal faces enclosing the one or more magnetic flux-controlling cores 106. The upper and lower core covers of the enclosure 104 are absent along the thrust axis 122. In an alternative embodiment, the two faces may be absent, making the one or more pod units 102 open along the thrust axis 122. Alternatively, the two faces may be formed of non-ferromagnetic material. Stacking the one or more pod units 102 along the thrust axis 122 connects ferromagnetic core covers along each pod's four faces to corresponding core covers of adjacent stacked pod units, creating a path for magnetic flux to traverse across the one or more pod units 102.

In an illustrative embodiment of FIG. 1A depicts a specific annular base component comprising a single pod group of the one or more pod groups containing 12 pie pod units 102 assembled along a circular geometry. The circuit schematic is indicative of one of many options for the one or more pod group connectivity, switching, and polarity reversal from the power source 112 via an H-bridge to reverse the direction of net thrust generated by the annular base component. Other variants with lower pod cardinality or the one or more pod groups, using remote one-way semi-conductor switches connected to the H-bridge are possible but not listed. Alternative embodiments include polygonal pod units and pie pod units wherein the one or more pod units 102 are arranged along circular ferromagnetic rings.

An alternative base component embodiment comprises an annular arrangement of polygonal pod units inside a polygonal geometry where the edge of each pod unit 102 of the one or more units 102 is aligned with the edge of the polygon. In a preferred embodiment, polygonal pod units of type 102 are closely packed and in contact with each other. Certain annular geometries such as rectangles enable complete close packing that closes the inner radius of the annulus, resulting in a platform or grid component for cargo applications. Hollow tower components may optionally be capped on either ends with grid components of similar geometry. While a rectangular ring other polygonal base shapes such as pentagon, hexagon and octagon are viable embodiments. Variants with base shapes having three edges or those with more than eight edges may be less preferred. Alternative geometries for flux linkage between pod units within and across levels are possible but not illustrated and fall within the scope of this embodiment.

FIG. 2 illustrates an exemplary one or more Micro-Electro-Mechanical Systems (MEMS) unit 200, in accordance with an embodiment of the present disclosure.

According to an exemplary embodiment of the present disclosure, the electromagnetic propulsion device 100 is formed by fabrication on a printed circuit board (PCB) 202 as the one or more MEMS units 200. The PCB 202 is configured with a double-sided PCB with copper traces 204 interspersed with the one or more magnetic flux-controlling cores 106 comprises at least one of: ferrite rings, thin films, ferromagnetic material, and the like are powder deposition into cavities routed in PCB 202. The PCB 202 may be comprising one of a: fire-retardant (FR)-4 and glass fibre (G)-10. Two or more magnetic materials 108 of the one or more pairs of magnetic materials 108 are positioned towards either side of one or more magnetic flux-controlling cores 106 with their like poles facing the one or more magnetic flux-controlling cores 106. The one or more electrically conductive elements 110 associated with the one or more MEMS units 200 etched on a first surface 206 and a second surface 208 of the PCB 202.

In an alternative embodiment of MEMS units 200 may use ferromagnetic thin films or other metamaterials such as Magnonic crystals, thin or thick film mag-nets situated in one or more locations along the PCB 202 to direct magnetic flux towards the periphery of the one or more electrically conductive elements 110. In alternative embodiments, magnetic poles in the one or more pairs of magnetic materials 108 may be radially oriented with one or more pairs of unlike poles facing each other and positioned along a plane of the PCB 202. In an alternative embodiment, the MEMS units 200 may also use radial spoke or discs instead of concentric annular-shaped one or more magnetic flux-controlling cores 106. The copper traces 204 may be spiral or con-centric polygonal arms with a transverse section connecting adjacent annular arms to realise a multi-turn coil. The PCB 202 may contain the one or more MEMS units 200. The architecture, connectivity and concepts remain the same as that of electromagnetic propulsion device 100 including the one or more pod groups that are electrically connected via traces to a common H-bridge triggered by the communication network 126 connected to a PCB antenna and the power source 112.

FIG. 3A illustrates an exemplary side view of a rectangular pod unit 300 with the one or more electrically conductive elements 110 symmetrical to the one or more magnetic flux-controlling cores 106, in accordance with an embodiment of the present disclosure.

In an illustrative embodiment, the rectangular pod units 300 configured with four or more magnets 108 with like poles oriented towards the one or more magnetic flux-controlling cores 106 of flat profile and even thickness wherein the magnets may be disposed at a specified distance as well as angular orientation relative to the surface of the one or more magnetic flux-controlling cores 106. The rectangular pod units 300 has the enclosure with the ferromagnetic material covers along the thrust axis 122. In an alternative embodiment, the rectangular pod units 300 excludes the enclosure but includes all other components of the one or more pod units 102. In an alternative exemplary embodiment, Unlike the one or more pod unit 102, the rectangular pod units 300 requires an external ferromagnetic core to link magnetic flux between the rectangular pod units 300. In an alternative exemplary embodiment, includes the enclosure 104 but omits axial enclosure normal to the thrust axis 122. This type of pod unit is designed to be stacked like in a Tower component geometry. Stacking the rectangular pod units 300 along the thrust axis 122 connects inner and outer ferromagnetic cores across adjacent pod units creating a path for magnetic flux to traverse across pod units.

FIG. 3B illustrates an exemplary side view of the rectangular pod unit 300 with the one or more electrically conductive elements 110 asymmetrical to the one or more magnetic flux-controlling cores 106, in accordance with an embodiment of the present disclosure. The placement of the one or more magnetic flux-controlling cores 106 and the one or more pairs of magnetic materials 108 relative to the one or more electrically conductive elements 110 may optionally be asymmetric so that the centre axis of the one or more magnetic flux-controlling cores 106 is not aligned with the centre axis of the of the one or more electrically conductive elements 110.

FIG. 3C illustrates an exemplary three-dimensional space representing direction of forces in the rectangular pod unit 300, in accordance with an embodiment of the present disclosure. As the one or more pairs of magnetic materials 108 is configured to provide the magnetic field in the radial axis of the one or more pod units 102, whereas the DC supplied by the power source 112 is orthogonal to the provided magnetic field and the DC. Further, the unidirectional force is the thrust force generated perpendicular to the magnetic field and the DC towards the trust axis 122 of the one or more pod units 102 and the rectangular pod units 300.

FIG. 4 illustrates an exemplary isometric view of the one or more pod units 102 with the pie shape 400, in accordance with an embodiment of the present disclosure.

In an exemplary embodiment, the one or more pod units 102 with the pie shape 400 may have four or more magnetic materials 108a that are thinner and of different aspect ratios of arc length to radial length as compared to magnets used in FIG. 1A. In an alternative embodiment, the one or more pod units 102 with the pie shape 400, the upper magnets are oriented towards the one or more magnetic flux-controlling cores 106 along symmetrically opposite edges. The bottom magnets are aligned along the other pair of edges of the one or more magnetic flux-controlling cores 106 that are perpendicular to the upper magnets. In an alternative embodiment, one or more pod units 102 with a new ferromagnetic core piece of different thickness is attached to one face of the one or more magnetic flux-controlling cores 106. In an alternative embodiment, the one or more pod units 102 comprises two ferromagnetic core pieces attached to either faces of the one or more magnetic flux-controlling cores 106 where one piece is thicker than the other. In an alternative embodiment, the one or more pod units 102 with the one or more pairs of magnetic materials 108 located inside are magnetic poles that are all oriented towards the one or more magnetic flux-controlling cores 106, which is 90 degrees, unlike other variants. An alternative embodiment, the one or more pod units 102 with the pie shape 400 has a bigger aspect ratio of arc length to radial length as compared to the illustrative pie pod 400 in FIG. 4, which has a smaller aspect ratio but the same internal constituents. The one or more pod units 102 are used in circular ring and grid components (C-CR3 and C-CP2).

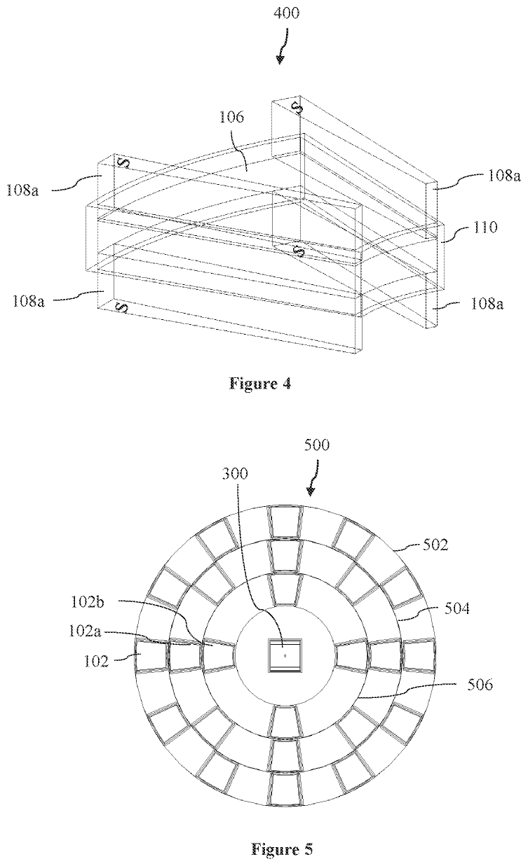

FIG. 5 illustrates an exemplary circular grid component 500, in accordance with an embodiment of the present disclosure.

In an exemplary embodiment, the circular grid component 500 comprises angularly separated one or more pod units 102 as depicted in FIG. 1A on concentric rings 502, 504, 506. The one or more pod units 102 with different dimensions are referred to as 102a and 102b with the same pie shape. Each ring may have a different number and embodiment of the one or more pod units 102, 102a, 102b arranged along the concentric rings 502, 504, 506. Linear thrust may be incremented in steps by activating each concentric ring of one or more pod units 102, 102a, 102b. A more continuous increment in linear thrust is obtained by activating one or more pod pairs that are symmetrically disposed about the central axis within one or more concentric rings 502, 504, 506 of the one or more pod units 102, 102a, 102b, designated for finer thrust control. A subset of pod units on concentric ring 502 have built-in switches that may be triggered independently in response to commands from the control unit 114.

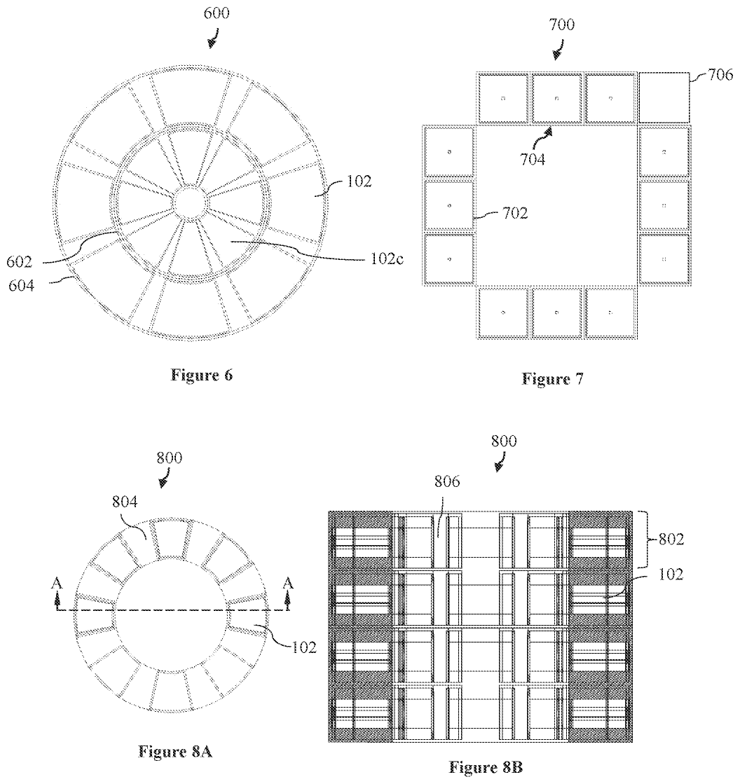

FIG. 6 illustrates an exemplary top view of concentric arrangements of the one or more pod units 102 on a flat disc 600 resulting in a circular grid of pod units, in accordance with an embodiment of the present disclosure.

In an exemplary embodiment, the concentric arrangements of the one or more pod units 102 on the flat disc 600 resulted in the circular grid of pod units 102, and 102c of differing size and aspect ratio on concentric rings 602, and 604 respectively. Each concentric ring 602 and 604 has a different characteristic output force due to differences in geometry and size of the one or more pod units 102, 102c. Unlike the circular grid component 500 the number of one or more pod units 102 per concentric rings 602 and 604 remain constant. Alternatively, this circular grid of pod units may be composed of concentric annular ring components wherein each ring is attached to its adjacent ring with a bigger radius and may optionally comprise a different pie pod variant.

FIG. 7 illustrates an exemplary annular arrangement of polygonal pod units 700, in accordance with an embodiment of the present disclosure.

In an exemplary embodiment, the annular arrangement of polygonal pod units 700 outside a polygonal geometry 702 where an edge 704 of each pod unit is aligned with the edge 704 of the polygon. At the intersection of two ring edges, the corners 706 of two polygonal pod units arranged along each edge intersect. A rectangular ring variant using rectangular pod units 300. At the corners of the rectangle, corners of the pod unit are in contact along their diagonal as illustrated. Other polygonal base shapes such as pentagons, hexagons and octagons are viable embodiments. Variants with base shapes having three edges or those with more than eight edges may be less preferred. Alternative geometries for flux linkage between pod units within and across levels are possible but not illustrated and fall within the scope of this model.

An alternative Component embodiment comprises pie pod units arranged in annular geometry of equal radius per level. Each level is stacked vertically so that a pod from a lower level is in contact and vertically below a corresponding pod unit from the upper level. The frame of the vehicle that incorporates this pod unit geometry may be of any load-bearing material such as structural steel, aluminium or composites that are well-known in the art. Magnetic flux pathways are vertical in this model across levels in the tower via the outer ferromagnetic core encasing each pod unit.

FIGS. 8A and 8B illustrate an exemplary top view and the sectional view of a multi-level circular tower 800, in accordance with an embodiment of the present disclosure.

In an exemplary embodiment, the multi-level circular tower 800 is formed by vertically stacking ring components at each level. Each level of the multi-level circular tower 800 comprises one or more pod units 102 with a pie shape. The pie-shaped pod units are arranged at equal angular intervals between annular ring cores 804. FIG. 8B illustrates four vertically stacked ring components with empty slots at regular angular intervals 806 that may house wires or one or more sensors 118 or other securing mechanisms including motorised helical screws that may be used to secure each ring component 802 to the vertically adjacent ring. This feature enables an individual ring component 802 to dynamically separate and be controlled autonomously while the rest of the multi-level circular tower 800 is controlled by one or more centralised control units 114.

An alternative circular tower component embodiment is composed of a cylindrical tower component and two end caps at either end that may either be Circular Grid components or alternatively annular disc components. In an alternative embodiment, the end caps may not contain the one or more pod units 102 and may be made from ferromagnetic core rings on either ends of the cylinder. The model is not encased in the enclosure 104 and is intended for vehicles with lower resultant magnetic fields arising from magnets and DC currents in coils.

An alternative cylindrical tower Component embodiment with tapered end caps is composed of a cylindrical tower component in the middle with tapered end caps at either end comprising a single or multi-level grid component or an annular disc component. The model is not encased in the enclosure 104 and is intended for vehicles with lower resultant magnetic fields arising from magnets and DC currents in coils.

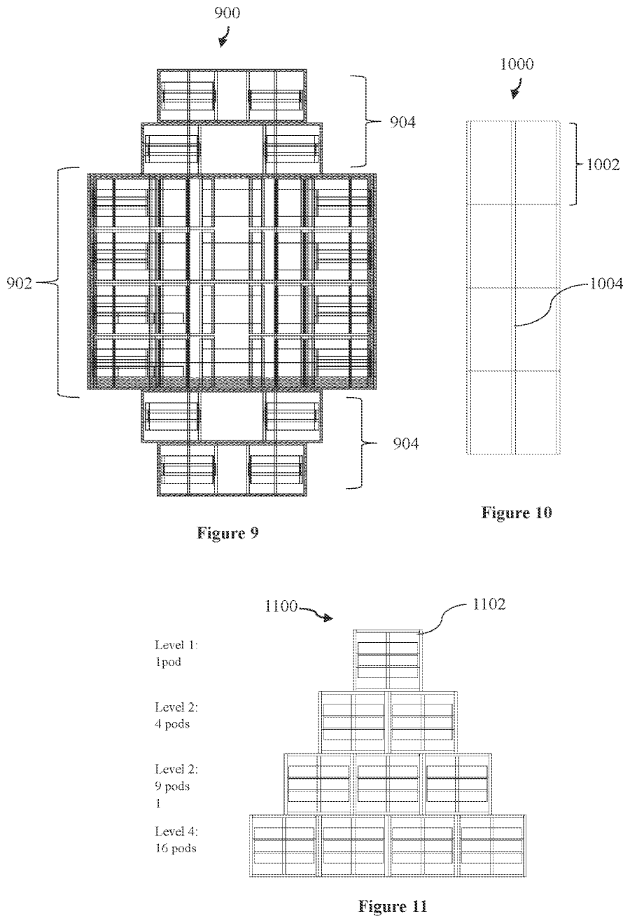

FIG. 9 illustrates an exemplary sectional view of an alternative cylindrical tower 900, in accordance with an embodiment of the present disclosure.

In an exemplary embodiment, the alternative cylindrical tower 900 is composed of two components, a core cylindrical tower component 902 between one or two end caps comprising the multi-level pyramidal component 904.

FIG. 10 illustrates an exemplary solid polygonal tower component 1000, in accordance with an embodiment of the present disclosure.

In an exemplary embodiment, the solid polygonal tower component 1000 comprises polygonal pod units 1002 stacked along the thrust axis 122 so that inner and outer ferromagnetic cores 1004 of adjacent pod units are in contact. This creates magnetic flux pathways via pod units across levels in the solid polygonal tower component 1000. An alternative solid polygonal tower Component embodiment comprises the rectangular pod units 300 stacked along the thrust axis 122 so that ferromagnetic core 1004 covers of adjacent pod units are in contact. This creates magnetic flux pathways across levels in the tower via ferromagnetic core covers encasing each pod unit.

An alternative multi-level stepped pyramid component embodiment is made of pod units arranged in a grid at each level of the stepped pyramid. The Solid stepped pyramid is constructed by stacking polygonal grid components with tapering width (pod cardinality per component) per level so that the overall height-to-width ratio of the resulting pyramid as well as the ratio of widths of vertically consecutive polygonal grids confirms pyramid geometry specifications. The one or more pod unit count at each level L of the pyramid starting from the top is L².

An alternative polygonal stepped pyramid Component embodiment comprises polygonal pod units stacked along the thrust axis 122 in a tower assembly. Rather than arranging multiple pod units of equal dimension in pyramidal geometries, this embodiment stacks one pod with differing dimensions per pyramid level. The two pyramid ratio variants as well as height-to-width ratios are consistent with the pyramid geometry.

In an alternative polygonal pyramid or tower Component embodiment of the present disclosure, each stacked layer of the polygonal pyramid or tower comprises rows of pod units arranged in arithmetic progression with the centre of each pod's edge aligned with the endpoints of two of its adjacent pod units from the next row. The resulting pod cardinality as a function of row ‘r’ in each layer is an arithmetic sequence with positive common difference up to the diagonal and negative common difference thereafter:

$$c ( r ) = \{ \begin{matrix}c ( r - 1 ) + 1 , & 1 \leq r \leq m \\ c ( r - 1 ) - 1 , & m < r < 2 m\end{matrix}$$

FIG. 11 illustrates an exemplary a four-level polygonal stepped pyramid component 1100, in accordance with an embodiment of the present disclosure.

In an exemplary embodiment, the four-level polygonal stepped pyramid component 1100 is constructed by stacking polygonal rings with tapering width and pod count per level so that the overall height-to-width ratio of the resulting pyramid as well as the ratio of widths of vertically adjacent polygonal rings confirm to pyramid geometry specifications. In a preferred embodiment, the polygonal pod units 1102 of the one or more pod units 102 are closely packed and in contact with each other forming magnetic flux pathways across pyramid levels via ferromagnetic pod covers. The number of one or more pod units 102 per level L is max [1, 4(L−1)].

In an exemplary embodiment, the multi-level pyramid component based on the four-level polygonal stepped pyramid component 1100 is constructed by stacking polygonal rings with tapering width and the one or more pod units 102 count per level so that the overall height-to-width ratio of the resulting pyramid as well as the ratio of widths of vertically adjacent polygonal rings confirm to pyramid geometry specifications. The number of pod units per level L is max [1, 4(L−1)].

FIG. 12A illustrates an exemplary top view multi-level circular stepped pyramid Component 1200, in accordance with an embodiment of the present disclosure.

FIG. 12B illustrates an exemplary sectional view of the multi-level circular stepped pyramid Component 1200, in accordance with an embodiment of the present disclosure.

In an exemplary embodiment, the multi-level circular stepped pyramid component 1200 is formed by stacking circular geometry based on pie pod units rings with tapering width and pod count per level so that the overall height-to-width ratio of the resulting pyramid as well as the ratio of widths of vertically adjacent rings confirm to pyramid geometry specifications. The multi-level circular stepped pyramid component 1200 contains different pie pod 1204 and 1202 respectively. The number of levels, pod embodiments and pod cardinality in 1200 may vary, driven by application requirements. Alternative geometries for flux linkage between pod units within and across levels are possible but not illustrated and fall within the scope of this model. FIG. 12B represents the sectional view of the multi-level circular stepped pyramid component 1200 depicting a two-level stepped pyramid from stacked rings 1206 confirming to the specification. The heterogenous pie pod units 1202 and 1204 are encased in ferromagnetic disc covers 1208 that link and shield magnetic flux pathways across levels.

In an exemplary embodiment, the multi-level circular stepped pyramid component 1200 comprises polygonal pod units arranged along circular ferromagnetic core rings at each level with an optional central polygonal pod at the apex. The stepped pyramid may optionally be constructed by stacking polygonal rings with tapering width and the one or more pod units 102 count per level so that the overall height-to-width ratio of the resulting pyramid as well as the ratio of widths of vertically adjacent polygonal rings confirms to pyramid geometry specifications.

In an exemplary embodiment, the multi-level circular stepped pyramid component 1200 comprises polygonal pod units arranged along circular ferromagnetic core rings at each level with an optional central polygonal pod at the apex. The stepped pyramid may optionally be constructed by stacking polygonal rings with tapering width and pod count per level so that the overall height-to-width ratio of the resulting pyramid as well as the ratio of widths of vertically adjacent polygonal rings confirm to pyramid geometry specifications.

In an exemplary embodiment, the multi-level circular stepped pyramid component 1200 comprises pie pod embodiments arranged along circular ferromagnetic core rings at each level with an optional central polygonal pod at the apex. This is one exemplary embodiment of the heterogenous pod units. Optionally each level may contain pod units of a different embodiment making it heterogenous. The stepped pyramid is constructed by stacking polygonal rings with tapering width and pod count per level so that the overall height-to-width ratio of the resulting pyramid as well as the ratio of widths of vertically adjacent polygonal rings confirm to pyramid geometry specifications. Magnetic flux linkage is across ferromagnetic rings connecting pod units within each level and via pod units across levels. Alternative geometries for flux linkage between pod units within and across levels are possible but not illustrated and fall within the scope of this model.

### Sample Vehicle Geometries:

The vehicle geometries may aggregate one or more components. Each component may form a vehicle. Each component geometry cited in this disclosure is also a vehicle geometry by itself. While specific electro-mechanical attributes associated with this invention are cited in the following the vehicle embodiments, the vehicle may have additional mechanisms and components for locomotion such as wheels, landing gear, aerodynamic devices and control surfaces known in the art to reduce drag and increase lift.

The vehicle configured with a tower structure is obtained by assembling a plurality of tower components of polygonal geometry side by side and/or by stacking one tower on another along the body axis of the vehicle, according to one embodiment of the present disclosure. The vehicle may optionally have a curved external shell for better aerodynamics.

FIG. 13 illustrates an exemplary sectional view of a vehicle with a multi-level circular stepped pyramid with conical shell 1300, in accordance with an embodiment of the present disclosure.

In an exemplary embodiment, the vehicle with the multi-level circular stepped pyramid with conical shell 1300 is configured with a pie pod units 1302 with an exterior encasing conical ferromagnetic core-shell 1304. The cabin 1306 may house living occupants or hardware, storage bays etc. The internal circular stepped pyramid structure may be composed of any circular pyramid component constructed using either polygonal or pie pod units. Many circular stepped pyramid Component embodiments including but not limited to FIGS. 12A and 12B are potential candidates for the internal skeletal structure of the vehicle. In some embodiments of the vehicle with the multi-level circular stepped pyramid with conical shell 1300 with lower specifications for current and magnetic field components the external conical shell 1304 may be made of non-magnetic material for increased structural strength or aerodynamic properties.

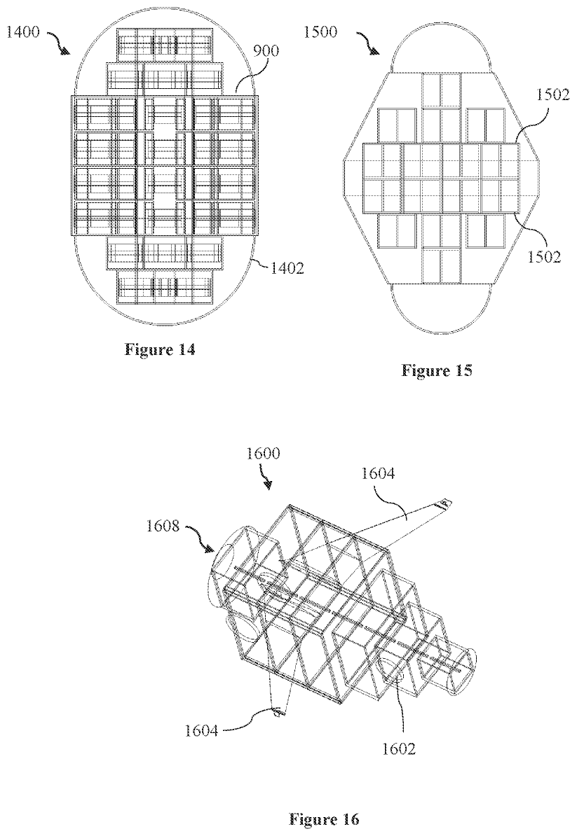

FIG. 14 illustrates an exemplary vehicle with a circular tapered tower vehicle 1400, in accordance with an embodiment of the present disclosure.

In an exemplary embodiment, the vehicle with the circular tapered tower vehicle 1400 comprising a FIG. 9 component with a hollow encasing aerodynamic curved shell 1402 that fully encloses the internal cylindrical tower 900, according to one embodiment of the present disclosure. The curved shell may be transparent or opaque and made from any lightweight material with low aerodynamic drag. It may optionally include drag-reduction devices such as Dimples, annular corrugations along the longitudinal axis, splines, serrations, etc.

In an alternative exemplary embodiment, the vehicle with the multi-level circular tapered tower vehicle comprising a core cylindrical tower component with an enclosing hollow exterior ferromagnetic shell is described according to one embodiment of the present disclosure. The external ferromagnetic casing is symmetrical and is shaped with aerodynamic curved surfaces that are cylindrical in the middle and curved at the ends unlike the conical shell casing in pyramidal models as depicted in FIG. 13. In yet another embodiment of a core cylindrical tower composed of pie pod units i.e., the one or more pod units 102 the external curved surface may be of non-ferromagnetic composite material whose utility is to reduce aerodynamic drag.

FIG. 15 illustrates an exemplary bi-cone vehicle 1500, in accordance with an embodiment of the present disclosure.

In an exemplary embodiment, the bi-cone vehicle 1500 is formed by stacking two polygonal pyramid components 1502 (multi-level stepped pyramid made of pod units arranged in a grid per pyramid level) at their base and reversing the current direction in pod groups within one of the pyramids. Another bi-cone vehicle embodiment using conical components, according to one embodiment of the present disclosure, is constructed by attaching two multi-level circular stepped pyramids or multi-level circular stepped pyramids using pod units with an exterior encasing conical ferromagnetic core-shell at their base and reversing current direction in the one or more pod groups within one of the conical pyramids.

In an alternative exemplary embodiment, a multi-level circular stepped pyramid vehicle may comprise either Pie or Polygonal pod units arranged in annular geometry per level of a stepped pyramid with no external ferromagnetic cores, according to one embodiment of the present technology. The platform or skeleton of the pyramid may be constructed from any structural material suitable for vehicle bodies. An optional central polygonal pod may be placed at the apex of the pyramid.

In an alternative exemplary embodiment, an alternative circular pyramid vehicle geometry may comprise polygonal pod units arranged in a multi-level circular stepped pyramid geometry, according to one embodiment of the present disclosure. Each unit is independent and there is no magnetic flux pathway across levels. The skeleton of such the vehicle may be formed of lightweight structural materials with relative permeability close to one, including but not restricted to carbon fibre composites, aluminium, fibreglass, etc.

In an alternative exemplary embodiment, an alternative circular pyramid vehicle geometry may comprise radially oriented polygonal pod units arranged across a multi-level circular stepped pyramid geometry, according to one embodiment of the present disclosure. Each unit is independent and pod faces are radially aligned. There is no magnetic flux pathway across levels. The skeleton of such the vehicle may be formed of lightweight structural materials with relative permeability close to one, including but not restricted to carbon fibre composites, aluminium, fibreglass, etc.

A potential vehicle embodiment with hyperboloid shape (V-H1), according to one embodiment of the present disclosure, may be realized by attaching pyramidal and inverted pyramidal components at their apex wherein the latter unit has current direction reversed in associated the one or more pod groups.

FIG. 16 illustrates an exemplary Short Take Off and Landing (STOL) vehicle 1600, in accordance with an embodiment of the present disclosure.

In an exemplary embodiment, the Short Take Off and Landing (STOL) vehicle 1600 is configured with a landing gear and retractable wheels 1602, foldable wings 1604, and an annular air intake vent 1606 at a nose end 1608. The STOL vehicle 1600 where the skeletal geometry comprises an assembly as depicted in FIG. 10 (solid polygonal tower component) sandwiched between two pyramidal components (multi-level stepped pyramid). An alternative vehicle embodiment with STOL vehicle 1600 capability comprising foldable wings 1604 with an air-foil cross-section that generates lift during horizontal flight. The foldable wings 1604 may be folded along one or more axes of rotation to align each folded wing 1604 with the longitudinal body axis (in the direction of the STOL vehicle 1600 and pod propulsion). The pod units generate horizontal thrust force that propels the STOL vehicle 1600 horizontally in flight as well as on land. The vehicle initially attains speed on a runway or road by retracting folded wings 1604 and increasing its rolling speed on the ground by activating one or more pod units to generate horizontal thrust. The STOL vehicle 1600 takes off from the ground attaining a ground speed that is sufficient to generate a lift force in the wings to counter its weight. Two of more retractable conventional wheels 1602 are provided for the vehicle to roll on ground that may be retracted in flight.

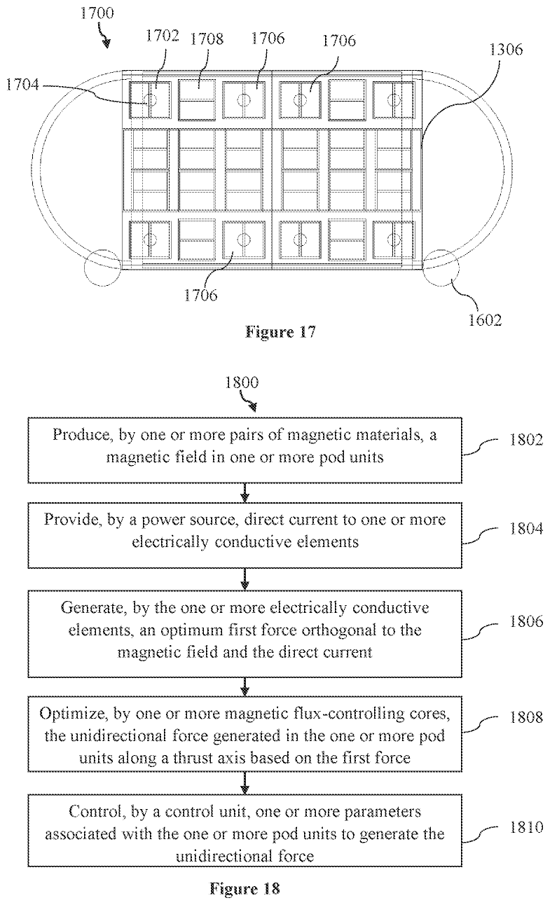

FIG. 17 illustrates an exemplary Vertical Take Off and Landing (VTOL) car 1700, in accordance with an embodiment of the present disclosure.

In an exemplary embodiment, the VTOL car 1700 with a similar layout as the STOL vehicle 1600 including retractable wheels 1602 but excluding foldable wings 1604 and an annular air intake vent at the nose end 1608. The VTOL car 1700 has rotatable pod units 1702 using rotary actuators 1704 such as servos to change thrust orientation from the rotatable pod units 1702 during take-off and cruise by rotating up to 90 degrees about its central axis that is parallel to the axis of rotation of the retractable wheels 1602. The cabin 1306 may house passengers, equipment, and cargo. An alternative embodiment of the VTOL car 1700 with non-rotatable pod units, excludes the rotary actuators 1704 and instead comprises the one or more pod groups with fixed rotary actuators 1704 in a vertical orientation and rotary actuators 1704 in a horizontal orientation that may be switched on/off mutually exclusively during the VTOL car 1700 and cruise operation respectively. An alternative embodiment that is not illustrated is a VTOL version that may have the same foldable wings 1604 configuration for passive lift generation as in the STOL vehicle 1600.

In one embodiment illustrated in FIG. 17, the VTOL car 1700 is achieved using counter rotary actuators 1704, wherein one or more rotary actuators 1704 are rotated by 90 degrees in pairs that rotate in opposite directions (Clockwise & counterclockwise) to cancel net reaction torque from rotation. When rotated this way, the current direction is reversed on rotation in alternating pod units to generate unidirectional vertical force.

In an alternative embodiment, the rotary actuators 1704 may be rotated in the same direction. In this model, non-rotatable pod units that are horizontally oriented may be activated asymmetrically around the body axis. For instance, if all servos are rotated clockwise, reaction torque tips the nose down. To counter that, one or more horizontally oriented upper pod units are turned off while lower pod units are on resulting in a clockwise torque about the centre of mass of the vehicle body. In an alternative but less preferred model, the vehicle may use conventional lift surfaces at the rear end such as ailerons to counter body rotation resulting from reaction torque.

In yet another embodiment, the one or more pod units are non-rotatable comprising vertical pod groups and horizontal pod groups. Vertical pod groups 1706 are activated during VTOL whereas horizontal pod groups 1708 may be always active or optionally only during horizontal flight. Motion on the ground is from rolling friction between tyres on wheels and the ground surface. The Horizontal propulsion is generated from the horizontal pod groups 1708 using the same technique and hardware components as an air-borne vehicle in flying mode.

FIG. 18 illustrates an exemplary flowchart of a method 1800 for generating the unidirectional force by an electromagnetic propulsion device 100, in accordance with an embodiment of the present disclosure.

According to an exemplary embodiment of the present disclosure, the method 1800 for generating the unidirectional force by an electromagnetic propulsion device is disclosed. At step 1802, the method 1800 begins by providing the magnetic field in the one or more pod units using the one or more pairs of magnetic materials. At step 1804, the method 1800 includes providing the DC by the power source to the one or more electrically conductive elements within the one or more pod units. At step 1806, the method 1800 includes the one or more electrically conductive elements generates the optimum first force orthogonal to the magnetic field and the DC. The first force refers to the Lorentz force. At step 1808, the method 1800 includes the one or more magnetic flux-controlling cores to optimize the net unidirectional force which is the vector sum of all forces generated within each pod unit of the one or more pod units along the thrust axis. Further, at step 1810, the method 1800 includes the control unit controlling the one or more parameters addresses of the one or more pod units to activate or deactivate to achieve a net thrust and torque to control trajectory.

FIG. 19 illustrates an exemplary graphical representation 1900 of components of forces, in accordance with an embodiment of the present disclosure.

In an exemplary embodiment, the graphical representation 1900 of components of the net unidirectional force along the thrust axis (Z axis) (Pod orientation axis) generated by each constituent within the one or more pod units of volume of 0.1 cm³ and 0.296 g mass, as a function of the DC to the one or more electrically conductive elements. The net force is a vector sum of all constituent forces with negative and positive values indicating direction along the thrust axis. It may be noted that net force is nonzero and that force in the one or more magnetic flux-controlling core materials appears to saturate at higher currents, likely as it approaches saturation magnetisation.

For instance, a tower base component may alternatively be constructed by alternating connections between inner and outer magnetic cores across adjacent levels of a tower. Mechanisms for constructing embodiments of pod units, base components, and vehicle geometries and control capabilities may be extended from the foregoing description of exemplary embodiments and core principles.

While specific language has been used to describe the invention, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

What is claimed is:

1. An electromagnetic propulsion device for generating unidirectional force, comprising:
one or more pod units, each pod unit of the one or more pod units comprises:
an enclosure configured to provide a structural support to each pod unit of the one or more pod units;
one or more magnetic flux-controlling cores operatively positioned inside the enclosure, configured to optimise the unidirectional force generated in each pod unit of the one or more pod units along a thrust axis;
one or more pairs of magnetic materials operatively positioned on opposite sides of the one or more magnetic flux-controlling cores, configured to provide a magnetic field;
one or more electrically conductive elements operatively positioned along a periphery of the one or more magnetic flux-controlling cores, configured to generate an optimum first force orthogonal to the magnetic field and the direct current;
a power source electronically connected to the one or more pod units, configured to provide direct current to the one or more electrically conductive elements; and
a control unit operatively connected to the one or more pod units and the power source, configured to control one or more parameters associated with the one or more pod units for generating the unidirectional force.

2. The electromagnetic propulsion device of claim 1, wherein one or more pod units configured to form one or more pod groups,
the one or more pod groups configured to form a base component by a fastening mechanism,
the one or more pod groups comprises one or more sensors and a transceiver module,
the one or more sensors operatively positioned proximal to each pod unit, configured to generate sensor data containing operational data of an associated pod unit of the one or more pod units; and
the transceiver module configured to transmit at least one of: telemetry data, the sensor data, system configuration data, status, and positioning data to the control unit through a communication network.

3. The electromagnetic propulsion device of claim 1, wherein the one or more pod units configured with a polygonal shape comprises one of a: rectangle shape, circle shape, pentagon shape, hexagon shape, and octagon shape.
a shape of the one or more magnetic flux-controlling cores and the shape of the one or more electrically conductive elements correlate with the polygonal shape of the one or more pod units.

4. The electromagnetic propulsion device of claim 1, wherein the one or more magnetic flux-controlling cores operatively positioned in the enclosure through one or more pairs of fasteners,
the one or more pairs of fasteners comprises screws, actuation units, magnetic clamps, spring-loaded pins, magnetic brackets, and snap-fit connectors.

5. The electromagnetic propulsion device of claim 1, wherein the one or more magnetic flux-controlling cores comprises a first surface;
the first surface configured with a first material with a relative permeability ranging between 1 and 200000 positioned normal to the thrust axis,
the first material is configured to generate an optimum magnetic field gradient.

6. The electromagnetic propulsion device of claim 1, wherein each pair of magnetic materials of the one or more pairs of magnetic materials is positioned on opposite sides of the one or more magnetic flux-controlling cores, with like poles directed towards the one or more magnetic flux-controlling cores,
each magnetic material within each pair of magnetic materials positioned on the one or more magnetic flux-controlling cores at a pre-defined distance and aligned in one of a: normal orientation and angular orientation.

7. The electromagnetic propulsion device of claim 1, wherein the one or more electrically conductive elements configured with a flat profile containing a defined number of windings,
the one or more electrically conductive elements selected from a group of superconducting materials exhibiting a Meissner Effect.

8. The electromagnetic propulsion device of claim 1, wherein electromagnetic propulsion device comprises one or more circuit components,
the one or more circuit components configured to connect the one or more pod units with the power source for controlling a flow of the direct current and polarity within each pod unit of the one or more pod units,
the one or more circuit components selected from a group comprises at least one of: diodes, metal-oxide-semiconductor field-effect transistors (MOSFETs), double-pole double-throw (DPDT) relays, solid-state switches, insulated-gate bipolar transistor (IGBT), and Semiconductor Controlled Rectifier (SCR).

9. The electromagnetic propulsion device of claim 1, wherein the one or more parameters comprises at least one of: activate and deactivate one or more pod units, regulate thrust levels, and change propulsion direction.

10. The electromagnetic propulsion device of claim 1, wherein the electromagnetic propulsion device is formed by fabrication on a printed circuit board (PCB) as one or more Micro-Electro-Mechanical Systems (MEMS) unit,
the one or more magnetic flux-controlling cores associated with the one or more Micro-Electro-Mechanical Systems (MEMS) units comprises at least one of: ferrite rings, thin films, and ferromagnetic material; and
the one or more electrically conductive elements associated with the one or more Micro-Electro-Mechanical Systems (MEMS) units etched on a first surface and a second surface of the printed circuit board (PCB).

11. A vehicle based on an electromagnetic propulsion device, the electromagnetic propulsion device configured for generating unidirectional force, comprising:
one or more pod units operatively form a structure of the vehicle in a pre-defined shape, configured to generate the unidirectional force,
wherein each pod unit of the one or more pod units comprises:
an enclosure configured to provide a structural support to each pod unit of the one or more pod units;
one or more magnetic flux-controlling cores operatively positioned inside the enclosure, configured to optimise the unidirectional force generated in each pod unit of the one or more pod units along a thrust axis;
one or more pairs of magnetic materials operatively positioned on opposite sides of the one or more magnetic flux-controlling cores, configured to provide a magnetic field;
one or more electrically conductive elements operatively positioned along a periphery of the one or more magnetic flux-controlling cores, configured to generate an optimum first force orthogonal to the magnetic field and the direct current;
a power source electronically connected to the one or more pod units, configured to provide direct current to the one or more electrically conductive elements; and
a control unit operatively connected to the one or more pod units and the power source, configured to control one or more parameters associated with the one or more pod units for propelling the vehicle in a defined direction.

12. The vehicle of claim 10, wherein the pre-defined shape is configured to provide a distributed propulsion and a control redundancy based on arranging the one or more pod units in defined geometries to form the structure of the vehicle.

13. The vehicle of claim 10, wherein the one or more pod units configured with a polygonal shape comprises one of a: rectangle shape, circle shape, pentagon shape, hexagon shape, and octagon shape to form the structure of the vehicle.

14. The vehicle of claim 10, wherein the one or more pod units configured to form one or more pod groups,
the one or more pod groups configured to form a base component by a fastening mechanism,
the one or more pod groups symmetrically disposed about a centre of mass of the vehicle,
the one or more pod groups operatively connected to the control unit through a communication network for triggering the one or more parameters in a coordinated manner; and
the one or more pod units within the one or more pod groups configured to generate the unidirectional force independently.

15. The vehicle of claim 10, wherein the one or more pod units operatively form the structure of the vehicle exterior to a cabin,
the cabin is selected from a group of magnetic shielding materials comprises at least one of: ferromagnetic materials, mu-metal alloys, and superconducting materials configured to mitigate electromagnetic interference.

16. The vehicle of claim 10, wherein the one or more parameters comprises at least one of: activate and deactivate one or more pod units, regulate thrust levels, and change propulsion direction.

17. The vehicle of claim 10, wherein the control unit is configured to:
orchestrate synchronized operation of the vehicle by controlling the one or more pod units configured at least one of: homogenously and heterogeneously to achieve a stepwise thrust control, desired trajectory, manoeuvres, acceleration, deceleration, and maintenance of constant speed;
remotely trigger the activation and deactivation of the one or more pod units for controlling the vehicle; and
alter the direction of propulsion by selectively activating the one or more pod units asymmetrically about a central body axis of the vehicle to produce a torque about the centre of mass of the vehicle for manoeuvring the vehicle.

18. The vehicle of claim 10, wherein the vehicle comprises a cooling subsystem,
the cooling subsystem configured to dissipate heat generated by the one or more pod units,
the cooling subsystem selected from a group comprises at least one of: air cooing subsystems, liquid cooling subsystems, and thermoelectric cooling subsystems.

19. The vehicle of claim 10, wherein the vehicle comprises one or more sensors,
the one or more sensors operatively positioned proximal to each pod unit, configured to generate sensor data containing positioning data, mapping data, navigation data, path planning data, waypoint navigation data, trajectory control data and course correction data.

20. A method for generating unidirectional force by an electromagnetic propulsion device, comprising:
providing, by one or more pairs of magnetic materials, a magnetic field in one or more pod units;
providing, by a power source, direct current to one or more electrically conductive elements;
generating, by the one or more electrically conductive elements, an optimum first force orthogonal to the magnetic field and the direct current;
optimising by one or more magnetic flux-controlling cores, the unidirectional force generated in the one or more pod units along a thrust axis based on the first force; and
controlling, by a control unit, one or more parameters associated with the one or more pod units to generate the unidirectional force.
